(19) United States
(12) Patent Application Publication
(10) Pub. No.: US 2018/0363817 A1
(43) Pub. Date: Dec. 20, 2018

(54) VIBRATION DAMPENING VENTILATION COUPLER

(71) Applicant: Systemair Mfg. Inc., Lenexa, KS (US)

(72) Inventor: Hamid Massali, Leawood, KS (US)

(73) Assignee: Systemair Mfg. Inc., Lenexa, KS (US)

(21) Appl. No.: 16/007,808

(22) Filed: Jun. 13, 2018

Related U.S. Application Data
(60) Provisional application No. 62/519,582, filed on Jun. 14, 2017.

(51) Int. Cl. F16L 27/103; F24F 13/02; F16L 3/10; F24F 7/06; F24F 13/26

(52) U.S. Cl. CPC F16L 27/103; F24F 13/0254; F24F 13/0209; F24F 2013/205; F24F 7/065; F24F 13/26; F16L 3/1025

(57) ABSTRACT

A ventilation system is operable to ventilate gases from an enclosed building. The ventilation system broadly includes a ventilation tube, a ventilation fan, and a flexible flow-through coupler. The tube is operable to extend into and out of the building for transmitting gases along the length of the tube. The fan is in fluid communication with the ventilation tube and is located to pump gases along the tube length. The coupler connects and fluidly communicates the fan to the ventilation tube, with the flexible coupler isolating at least part of the ventilation tube from vibration caused by the fan. The coupler comprises a flexible material with a Shore A hardness less than about 50.

### RELATED APPLICATION

This application claims the benefit of U.S. Provisional Application Serial No. 62/519,582, filed Jun. 14, 2017, entitled VIBRATION DAMPENING VENTILATION COUPLER, which is hereby incorporated in its entirety by reference herein.

### BACKGROUND

### 1. Field

The present invention relates generally to building ventilation systems. More specifically, embodiments of the present invention concern a radon ventilation system for a residential building.

### 2. Discussion of Prior Art

It is known in the art to use ventilation equipment in residential homes to ventilate radon gases from an enclosed space. Conventional radon ventilation systems include tubing to carry gases, as well as a powered fan fluidly communicating with the tubing. The tubing generally runs from the enclosed space to an exterior location outside the home. The fan is operable to pump gases from the enclosed space to the exterior location.

However, prior art ventilation systems have various deficiencies. For instance, fans used in conventional systems are known to produce excessive levels of vibration and noise. Over time, the vibration and noise produced by prior art systems can cause damage to the ventilation system itself and/or adjacent parts of the home. Furthermore, such vibration and noise are commonly noticeable by occupants of the home and can be distracting or annoying to the occupants.

### SUMMARY

The following brief summary is provided to indicate the nature of the subject matter disclosed herein. While certain aspects of the present invention are described below, the summary is not intended to limit the scope of the present invention.

Embodiments of the present invention provide a ventilation system that does not suffer from the problems and limitations of prior art systems (including but not limited to those identified above).

A first aspect of the present invention concerns a ventilation system to ventilate gases from an enclosed building. The ventilation system broadly includes a ventilation tube, a ventilation fan, and a flexible flow-through coupler. The tube is operable to extend into and out of the building for transmitting the gases along the length of the tube. The fan is in fluid communication with the ventilation tube and is located to pump gases along the tube length. The coupler connects and fluidly communicates the fan to the ventilation tube, with the flexible coupler isolating at least part of the ventilation tube from vibration caused by the fan. The flexible coupler comprises a flexible material with a Shore A hardness less than about 50.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a fragmentary side elevation of a ventilated building constructed in accordance with a first preferred embodiment of the present invention, with the building being sectioned to show a ventilation system mounted on a wall of the building, where the ventilation system includes a ventilation tube, a fan that fluidly communicates with the tube, and a pair of flexible, flow-through couplers attaching the fan to the tube;

FIG. 2 is an exploded perspective of the fan and the pair of couplers shown in FIG. 1;

FIG. 3 is a cross section of one of the couplers shown in FIGS. 1 and 2;

FIG. 4 is a fragmentary side elevation of a ventilated building constructed in accordance with a second preferred embodiment of the present invention, where the ventilation system includes an alternative ventilation tube, a fan that fluidly communicates with the tube, and an alternative pair of flexible, flow-through couplers attaching the fan to the tube;

FIG. 5 is a perspective of one of the couplers shown in FIG. 4; and

FIG. 6 is a cross section of the coupler shown in FIG. 5.

The drawing figures do not limit the present invention to the specific embodiments disclosed and described herein. While the drawings do not necessarily provide exact dimensions or tolerances for the illustrated components or structures, the drawings, not including any purely schematic drawings, are to scale with respect to the relationships between the components of the structures illustrated therein.

### DETAILED DESCRIPTION OF THE PREFERRED EMBODIMENTS

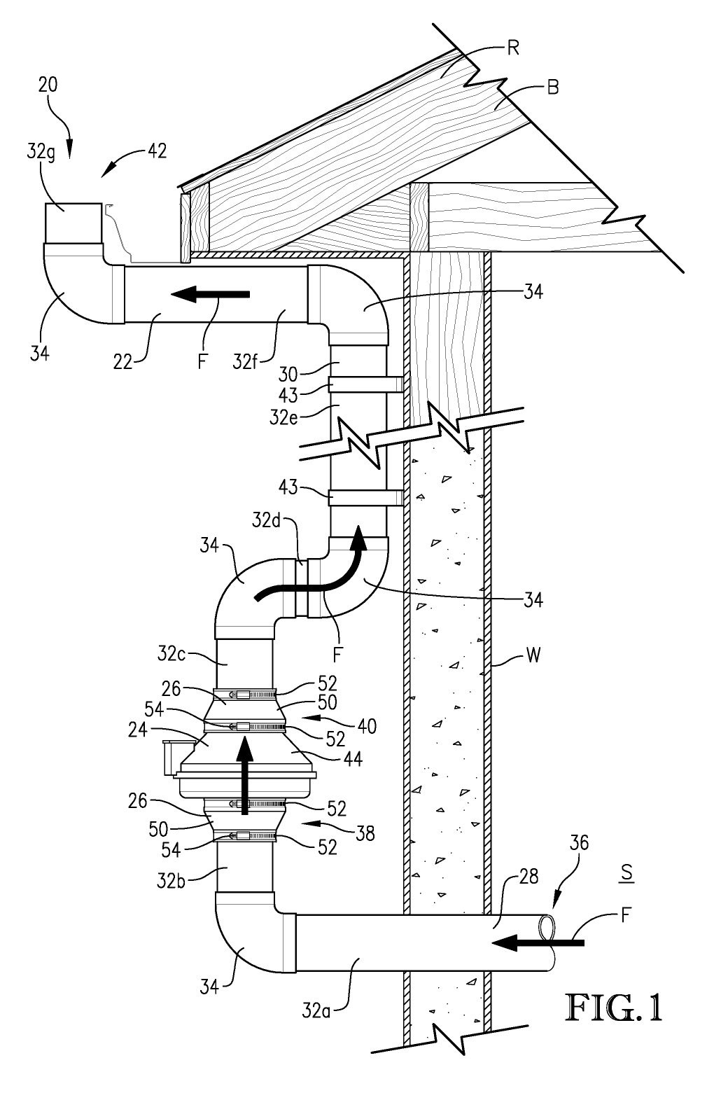

Turning initially to FIG. 1, a ventilation system 20 is configured to ventilate gases from an enclosed building B. The building B comprises a conventional residential structure with a roof R and walls W. The building B also forms an enclosed space S. The ventilation system is configured to carry gases in a flow direction F from the enclosed space S within the building B and discharge the gases to an ambient location outside the building B.

In the illustrated embodiment, the system 20 comprises a radon ventilation system operable to ventilate gases from the enclosed space. It will also be appreciated that the system 20 could be employed in other applications (e.g., for other purposes of ventilating an enclosed space in a residential or commercial building).

Although the depicted building B includes a single system 20, it will be understood that the building could be installed with multiple ventilation systems that alternatively or cooperatively ventilate gases from within an enclosed space. The ventilation system 20 preferably includes a ventilation tube 22, ventilation fan 24, and flexible flow-though couplers 26.

### Ventilation Tube and Fan

The illustrated ventilation tube 22 is operable to extend into and out of the building B for transmitting the gases along the length of the tube 22. The ventilation tube 22 preferably includes upstream and downstream tube sections 28,30.

Upstream tube section 28 preferably includes straight segments 32a,b and a curved elbow 34 secured to one another with adhesive (not shown). The upstream tube section 28 also defines an inlet 36 and an outlet 38. The segment 32a preferably extends into and out of the enclosed space S so that the inlet 36 is located within the enclosed space S.

However, it will be appreciated that the tube section 28 could be alternatively configured and/or positioned relative to the building B (e.g., to extend into and out of the enclosed space S). For instance, although the tube section 28 comprises a single conduit for carrying gasses, the tube section could comprise multiple parallel conduits.

Downstream tube section 30 includes straight segments 32c-g and curved elbows 34 secured to one another with adhesive (not shown). The downstream tube section 30 also presents an inlet 40 and outlet 42.

It will also be understood that the tube section 30 could be alternatively configured and/or positioned relative to the building. For example, although the tube section 30 also comprises a single conduit for carrying gasses, the tube section could comprise multiple parallel conduits.

In the illustrated embodiment, the tube sections 28,30 are spaced vertically relative to one another, with the inlet 40 of tube section 30 spaced above the outlet 38 of tube section 28. As will be explained, the inlet 40 and outlet 38 are spaced apart to permit positioning of the fan 24 therebetween.

In the illustrated embodiment, the downstream tube section 30 is removably secured to the wall W of building B with brackets 43. Each bracket 43 is mounted on the segment 32e and attached to the wall W with fasteners (not shown). It will also be appreciated that one or more brackets could be alternatively positioned along the system 20 for securement to the building B. Furthermore, the principles of the present invention are equally applicable where a structure other than the brackets is used to secure the system 20 relative to the building B.

The tube sections 28,30 preferably comprise a conventional polyvinyl chloride (PVC) material. However, it is within the ambit of the present invention where the ventilation tube includes an alternative synthetic resin material. For some aspects of the present invention, the ventilation tube could additionally or alternatively include other materials, such as a metallic material (e.g., carbon steel, aluminum, or stainless steel).

The depicted ventilation tube 22 preferably includes a pair of tube sections. However, it will be appreciated that the ventilation tube could take various configurations without departing from the scope of the present invention. For instance, the ventilation tube could comprise a single, unitary tube structure, with the fan being attached to the inlet or outlet of the tube structure. Again, as noted above, the tube 22 could include multiple tube sections arranged in parallel with one another.

The depicted ventilation tube 22 is arranged so that the tube section 30, along with the fan 24 and part of the tube section 28, is located outside the building B. It is also within the scope of the present where the ventilation tube 22 is alternatively routed outside or inside the building to suitably ventilate gases. For instance, the downstream tube section could be substantially or entirely located within the building so that the ventilation tube and fan are not exposed to ambient conditions.

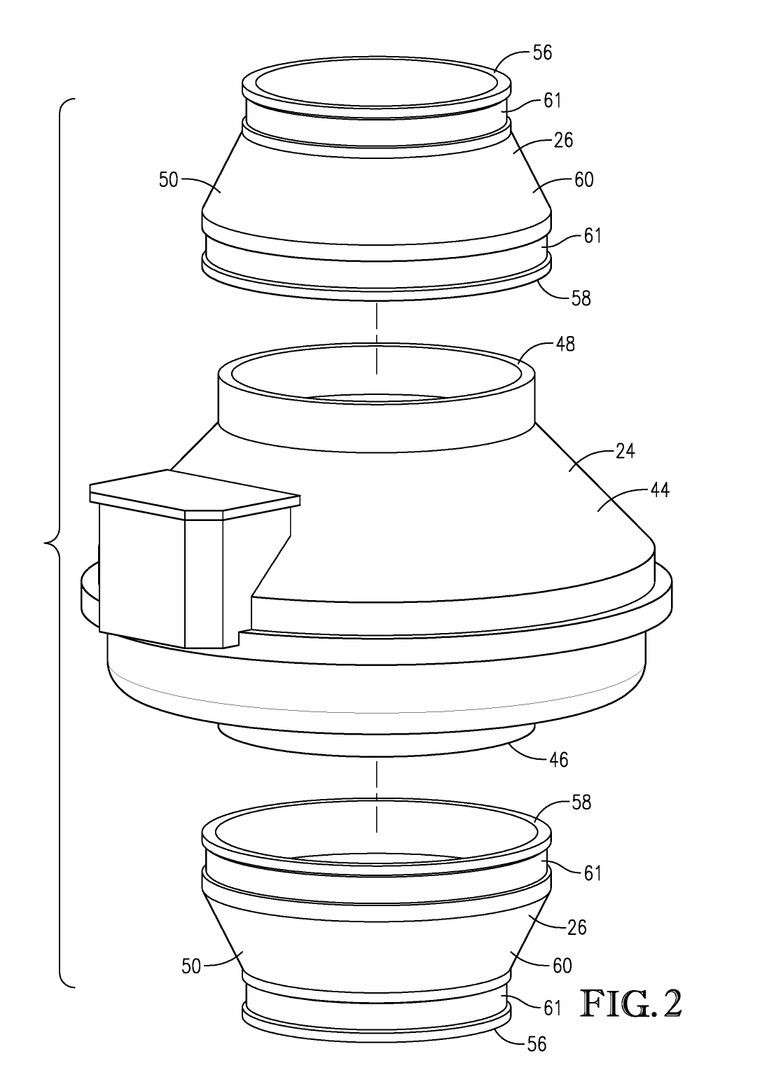

Turning to FIGS. 1 and 2, the ventilation fan 24 fluidly communicates with the ventilation tube 22 and is located between the tube sections 28,30 to pump gases in the flow direction F along the tube length.

The ventilation fan 24 includes a housing 44, a fan blade (not shown) rotatably mounted in the housing 44, and an electric motor (not shown) that drives the fan blade. The housing 44 preferably presents a tubular inlet fan end 46 and a tubular outlet fan end 48 (see FIG. 2). The fan ends 46,48 communicate with the fan blade so that the fan blade is operable to move gases through the housing 44 from one end 46 to the other end 48.

As will be discussed, the flexible couplers 26 connect and fluidly communicate the fan 24 to respective tube sections 28,30, with the flexible couplers 26 isolating the respective tube sections 28,30 from vibration caused by the fan 24.

In the illustrated embodiment, the fan ends 46,48 are preferably spaced vertically relative to one another and adjacent to corresponding tube sections 28,30. However, it is also within the ambit of the present invention where the fan is alternatively oriented. For instance, the fan could be arranged so that the fan ends are positioned laterally alongside each other (e.g., where the flow direction through the fan is horizontal).

The principles of the present invention are equally applicable where the fan 24 has an alternative configuration. For instance, one or more of the housing, fan blade, and motor could have an alternative construction.

Although the fan 24 is preferably located between the tube sections 28,30, the fan 24 could be alternatively positioned along the tube length. For instance, the fan could be located at the inlet of the upstream tube section. In another alternative embodiment, the fan could be located at the outlet of the downstream tube section.

While the disclosed system 20 includes a single fan 24, it is within the ambit of the present invention for the system to utilize a plurality of fans for pumping gases along the tubing. For example, the system could have multiple fans positioned at locations along the length of a common tube (such as tube 22).

The illustrated fan 24 is preferably located outside the building B. But it is within the scope of the present where the fan is alternatively located outside or inside the building to suitably ventilate gases. For instance, the fan could be substantially or entirely located within the building so that the fan is not exposed to ambient conditions.

### Flexible Flow-Through Couplers

The flexible flow-through coupler 26 of the present invention preferably connects the fan 24 to the ventilation tube 22. More particularly, the coupler 26 fluidly communicates the fan 24 with the ventilation tube 22 to permit fluid flow therebetween. Each coupler 26 preferably isolates at least part of the ventilation tube 22 from vibration caused by the fan 24.

In the illustrated embodiment, each coupler 26 includes a tubular coupler body 50 and a pair of hose clamps 52. The hose clamps 52 are conventional and include a rotatable screw 54 to adjust the diameter of the hose clamp 52. However, the hose clamps 52 could have an alternative configuration.

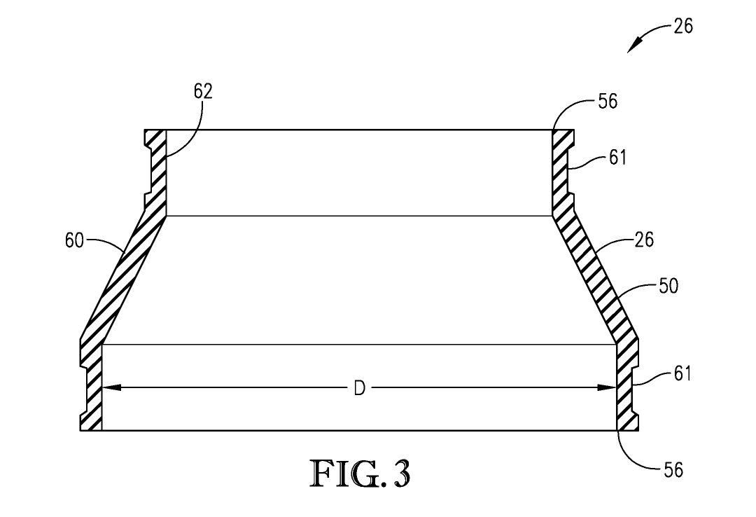

The coupler body 50 presents opposite coupler ends 56,58 and a tapered section 60 located between the ends 56,58 (see FIG. 3). The coupler body 50 presents an outer surface that defines endless annular grooves 61 located at coupler ends 56,58 to receive the hose clamps 52. The coupler body 50 presents a passage 62 that extends continuously from coupler end 56 to coupler end 58. The passage 62 defines a passage diameter dimension D.

In the illustrated embodiment, the dimension D at the coupler end 56 preferably ranges from about two inches (2″) to about six inches (6″) and, more preferably, is about four and a half inches (4.5″). The dimension D at the coupler end 58 preferably ranges from about three inches (3″) to about eight inches (8″) and, more preferably, is about six inches (6″). Although the coupler body 50 is preferably tapered, as will be shown in a subsequent embodiment, the coupler body could be alternatively shaped.

For each coupler 26, one coupler end 56,58 is configured to at least partly receive a corresponding tubular fan end 46,48, and the other coupler end 56,58 is configured to at least partly receive the corresponding tube section 28,30 of the ventilation tube 22. The hose clamps 52 are mounted on corresponding coupler ends 56,58 and removably secure the coupler ends 56,58 to the respective tubular fan end 46,48 and the ventilation tube 22.

Although the couplers 26 preferably at least partly receive the respective fan ends 46,48, the couplers 26 could be alternatively connected relative to the fan ends 46,48. For instance, the system could be configured so that the coupler is at least partly received by the respective fan end. In such an alternative configuration, a hose clamp can be placed on the fan end that receives the coupler end to secure the coupler in place.

Similarly, although the couplers 26 preferably at least partly receive the respective tube sections 28,30, the couplers 26 could be alternatively connected relative to the tube sections 28,30. For example, the system could be configured so that the coupler is at least partly received by the respective tube section. In such an alternative configuration, a hose clamp can be placed on the tube section that receives the coupler end to secure the coupler in place.

In other alternative embodiments, the coupler could be connected to the respective fan end and/or the respective tube section via another tubular structure that permits the flow of gases along the flow direction F.

Again, the couplers 26 connect and fluidly communicate the fan 24 to respective tube sections 28,30. The couplers 26 preferably isolate the respective tube sections 28,30 from vibration caused by the fan 24.

As noted above, the tube sections 28,30 are preferably spaced vertically relative to one another, with the fan ends 46,48 positioned adjacent the corresponding tube sections 28,30. Each coupler 26 preferably extends vertically between the respective tubular fan end 46,48 and the corresponding tube section 28,30.

The coupler 26 preferably includes an elastomeric material. The elastomeric material comprises a synthetic resin material, although a natural elastomeric material could also be used. It is also within the scope of the present invention where the coupler 26 includes a synthetic resin material that is not elastomeric.

More preferably, the elastomeric material includes an ethylene propylene diene monomer material and/or a polyvinyl chloride material. However, certain aspects of the present invention encompass a coupler including additionally or alternatively one or more other materials.

In various preferred embodiments, the coupler material has a Shore A hardness of at least 20, 25, 30, 35, 40, 45, 50, or 55. Additionally or alternatively, in various preferred embodiments, the coupler material has a Shore A hardness of less than 60, 55, 50, 45, 40, 35, 30, or 25. In one or more embodiments, the coupler material most preferably has a Shore A hardness ranging from about 30 to about 40.

The preferred coupler material preferably enables the couplers to support the fan 24 relative to the tube 22. Furthermore, the coupler material permits the couplers to isolate the tube 22 from any undue force and vibration created by the fan 24.

The coupler body 50 is preferably removably secured to the respective tubular fan end 46,48 and the ventilation tube 22 with hose clamps 52. Again, the hose clamps could have an alternative construction for securing the coupler body 50. Furthermore, it is within the scope of the present invention where an alternative fastener configuration is used to secure the coupler body. For example, the coupler body and the adjacent connected component (such as a fan end or a tube section) could include complemental connectors that are removably connected to each other by a snap-fit connection or by a threaded connection.

### Operation

In use, the ventilation system 20 is configured to move gases in the flow direction F from the enclosed space S to a location outside the building B. The fan blade of the fan 24 includes a fan blade is spun by an electric motor to move gases from the inlet fan end 46 to the outlet fan end 48. In this manner, the fan 24 induces a flow of gases through the tube 22 in the flow direction F. The couplers 26 cooperatively isolate the ventilation tube 22 from vibration caused by the fan 24 during operation.

### Alternative Embodiment

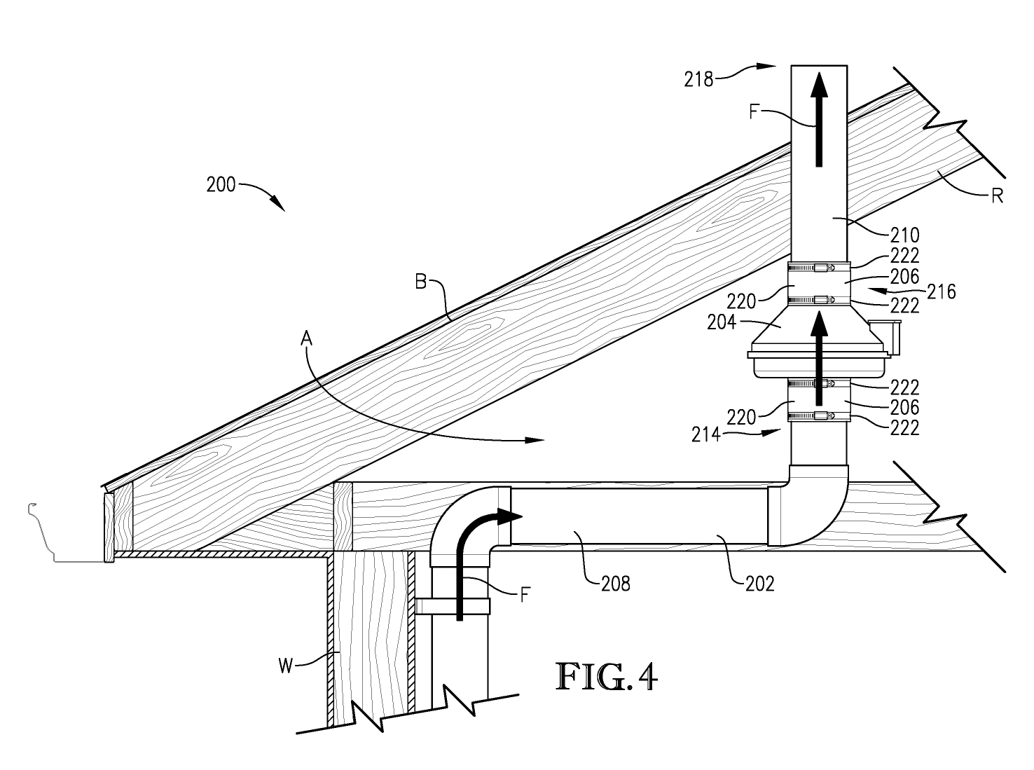

Turning to FIGS. 4-6, an alternative ventilation system 200 is constructed in accordance with a second embodiment of the present invention. For the sake of brevity, the remaining description will focus primarily on the differences of this alternative embodiment from the preferred embodiment described above.

The ventilation system 200 is configured to ventilate gases from an enclosed space (not shown) within the building B. The building B includes a roof R and walls W. The building B also presents an attic space A directly beneath the roof R. The ventilation system 200 preferably includes a ventilation tube 202, ventilation fan 204, and flexible flow-though couplers 206.

The illustrated ventilation tube 202 is operable to extend into and out of the building B for transmitting the gases along the length of the tube 202. The ventilation tube 202 preferably includes upstream and downstream tube sections 208,210.

The upstream tube section 208 defines an inlet (not shown) and an outlet 214. As in the previous embodiment, the inlet fluidly communicates with an enclosed space (not shown). Similarly, the downstream tube section 210 presents an inlet 216 and outlet 218.

As with the previous embodiment, the flexible flow-through coupler 206 preferably connects the fan 204 to the ventilation tube 202 to permit fluid flow therebetween. Each coupler 206 also preferably isolates at least part of the ventilation tube 202 from vibration caused by the fan 204.

In the illustrated embodiment, each coupler 206 includes a tubular coupler body 220 and a pair of hose clamps 222.

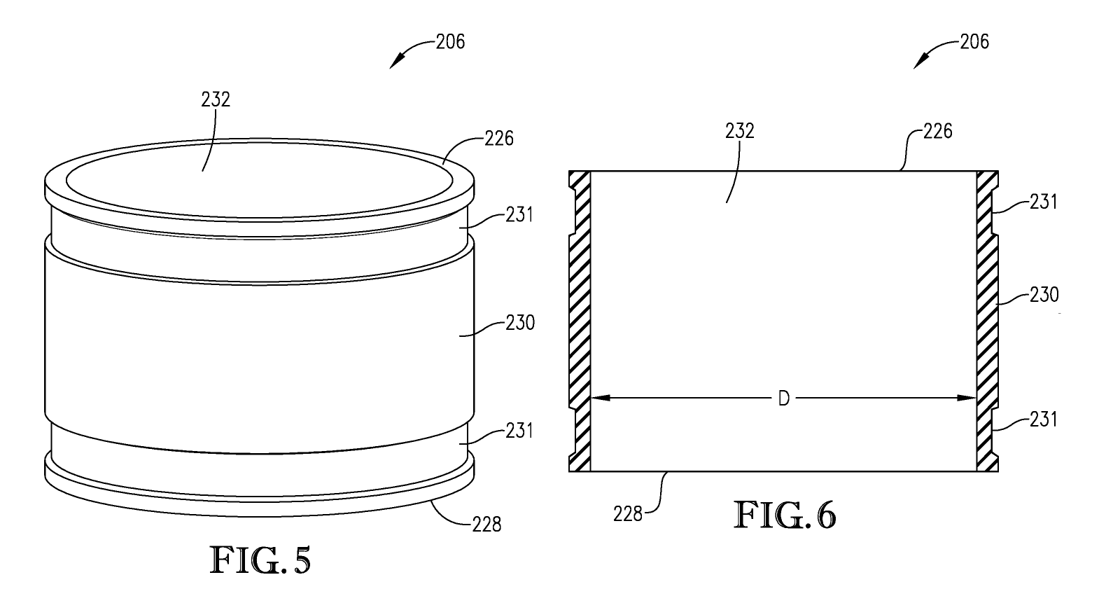

The coupler body 220 presents opposite coupler ends 226,228 and a generally straight central section 230 located between the ends 226,228 (see FIGS. 5 and 6). The coupler body 220 presents an outer surface that defines endless annular grooves 231 located at coupler ends 226,228 to receive the hose clamps 222. The coupler body 230 presents a passage 232 that extends continuously from coupler end 226 to coupler end 228. The passage 232 defines a substantially constant passage diameter dimension D. The dimension D of the illustrated coupler preferably ranges from about two inches (2″) to about eight inches (8″) and, more preferably, is about four and a half inches (4.5″).

The hose clamps 222 are mounted on corresponding coupler ends 226,228 and removably secure the coupler ends 226,228 to the respective tubular fan end and the ventilation tube 202.

As with the previous embodiment, the coupler 206 preferably includes an elastomeric material. More preferably, the elastomeric material comprises a synthetic resin material, although a natural elastomeric material could also be used.

The coupler material preferably has a Shore A hardness of at least 20, 25, 30, 35, 40, 45, 50, or 55. Additionally or alternatively, in various preferred embodiments, the coupler material has a Shore A hardness of less than 60, 55, 50, 45, 40, 35, 30, or 25. Most preferably, the coupler material has a Shore A hardness ranging from about 30 to about 40.

Although the above description presents features of preferred embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A ventilation system to ventilate gases from an enclosed building, said ventilation system comprising:
a ventilation tube operable to extend into and out of the building for transmitting the gases along the length of the tube;
a ventilation fan in fluid communication with the ventilation tube and located to pump gases along the tube length; and
a flexible flow-through coupler connecting and fluidly communicating the fan to the ventilation tube, with the flexible coupler isolating at least part of the ventilation tube from vibration caused by the fan,
said flexible coupler comprising a flexible material with a Shore A hardness less than about 50.

2. The ventilation system as claimed in claim 1,
said coupler including an elastomeric material.

3. The ventilation system as claimed in claim 2,
said elastomeric material including an ethylene propylene diene monomer material and/or a polyvinyl chloride material.

4. The ventilation system as claimed in claim 2,
said elastomeric material comprising a synthetic resin material.

5. The ventilation system as claimed in claim 2,
said material having a Shore A hardness ranging from about 30 to about 40.

6. The ventilation system as claimed in claim 1,
said ventilation fan presenting a tubular fan end,
said coupler including a tubular coupler body, with the coupler body presenting opposite coupler ends that connect to the tubular fan end and the ventilation tube, respectively.

7. The ventilation system as claimed in claim 6,
at least part of said tubular body tapering toward one of the coupler ends.

8. The ventilation system as claimed in claim 6,
said coupler ends at least partly receiving the tubular fan end and the ventilation tube, respectively.

9. The ventilation system as claimed in claim 8,
said coupler including a pair of hose clamps mounted on corresponding coupler ends and securing the coupler ends to the respective tubular fan end and the ventilation tube.

10. The ventilation system as claimed in claim 9,
said coupler including an elastomeric material.

11. The ventilation system as claimed in claim 10,
said elastomeric material including an ethylene propylene diene monomer material and/or a polyvinyl chloride material.

12. The ventilation system as claimed in claim 10,
said material having a Shore A hardness ranging from about 30 to about 40.

13. The ventilation system as claimed in claim 1,
said ventilation tube including a pair of tube sections, with at least one of the tube sections being operable to extend into and out of the building,
said ventilation fan being located between the tube sections to pump gases therebetween; and
a second flexible flow-through coupler,
said flexible couplers connecting and fluidly communicating the fan to respective tube sections, with the flexible couplers isolating the respective tube sections from vibration caused by the fan.

14. The ventilation system as claimed in claim 13,
said ventilation fan presenting opposite tubular fan ends associated with corresponding tube sections,
each of said couplers including a tubular coupler body, with each coupler body presenting opposite coupler ends that connect to one of the tubular fan ends and the corresponding tube section, respectively.

15. The ventilation system as claimed in claim 14,
said tube sections being spaced vertically relative to one another, with the fan ends positioned adjacent the corresponding tube sections,
each of said couplers extending vertically between the one tubular fan end and the corresponding tube section.

16. The ventilation system as claimed in claim 14,
at least part of said tubular body tapering toward one of the coupler ends.

17. The ventilation system as claimed in claim 14,
said coupler ends at least partly receiving one of the tubular fan ends and the corresponding tube section, respectively.

18. The ventilation system as claimed in claim 17,
each of said couplers including a pair of hose clamps mounted on corresponding coupler ends and securing the coupler ends to the respective tubular fan end and the corresponding tube section.

19. The ventilation system as claimed in claim 18,
each of said couplers including an elastomeric material.
said elastomeric material including an ethylene propylene diene monomer material and/or a polyvinyl chloride material.

20. The ventilation system as claimed in claim 18,
said material having a Shore A hardness ranging from about 30 to about 40.
